(19) United States
(12) Patent Application Publication
(10) Pub. No.: US 2012/0096977 A1
(43) Pub. Date: Apr. 26, 2012

(54) Operation lever for steering apparatus

(75) Inventors: Kouji Hirooka, Gunma-ken (JP); Suguru Sugishita, Gunma-ken (JP)

(73) Assignee: YAMADA MANUFACTURING CO., LTD., Gunma-ken (JP)

(21) Appl. No.: 13/137,990

(22) Filed: Sep. 23, 2011

(30) Foreign Application Priority Data
Oct. 20, 2010 (JP) 2010-235082
Aug. 1, 2011 (JP) 2011-168792

(51) Int. Cl. B62D 1/184; G05G 1/06

(52) U.S. Cl. 74/524

(57) ABSTRACT

An operation lever includes a lever main body A having a tapered insertion portion which has locking portions and in which the size in the up-down direction decreases gradually and an operation knob having a tapered insertion hole in which a size in the up-down direction decreases gradually from an opening toward a deep end wall surface. The insertion hole includes tapered reference surface facing each other in the up-down direction. Grooves are formed from the opening and along the deep end wall surface so as to protrude outward from the respective tapered reference surfaces and the inner side surfaces in the insertion hole of the operation knob. The insertion portion is inserted into the insertion hole and the locking portions bite in outward through the respective tapered reference surfaces.

### BACKGROUND OF THE INVENTION

1. Field of the Invention

The present invention relates to an operation lever for a steering apparatus that makes it possible to mount a knob on the lever rapidly and in an easy manner and enables extremely strong mounting in an assembly of an operation lever device constituting the steering apparatus provided with a tilt-telescopic function.

2. Description of the Related Art

A steering apparatus having a tilt-telescopic function is provided with an operation lever for locking and releasing in order to perform tilting and telescopic adjustment. The operation lever is typically constituted by a metallic lever and an operation knob made from a synthetic resin.

Japanese Patent Application Publication No. 2000-66750 discloses the structure of an operation lever device that is used for tilt operation in tilt steering and the contents thereof can be summarized as follows. An operation lever device 1 is constituted by a lever main body 10 and an operation knob 20. The lever main body 10 is formed by press punching a flat metal material. A knob mounting portion 12 is formed integrally with the distal end portion of the lever main body 10 in the process of press punching the lever main body 10.

The knob mounting portion 12 is formed in a tapered shape such that the width dimension of the distal end portion is less than the width dimension of the proximal portion thereof. Further, a plurality of locking portions 15, each having a substantially triangular shape, are formed in a sawtooth-like fashion at both sides of the knob mounting portion 12 in the push-in direction of the operation knob 20. When the plurality of locking portions 15 are processed by punching at both sides of the knob mounting portion 12, the knob mounting portion 12 is punched to have a tapered cross section such that the width dimension on the fracture side is less than the width dimension on the shear side.

The operation knob 20 is molded integrally by injection molding of a synthetic resin, and a boss portion 22 is formed in the central portion thereof. The boss portion has an insertion hole 23 for insertion and mounting on the knob mounting portion 12. The insertion hole 23 is formed in a tapered hole shape such as to be wide on the opening side and narrow on the deep side correspondingly to the shape of the knob mounting portion 12. The insertion hole 23 is formed to have a quadrangular cross section with a hole width dimension corresponding to the width dimension of the knob mounting portion 12 on the shear side in the cross section thereof. Therefore, the inner wall surface of the insertion hole 23 has a quadrangular cross section.

Protruding portions 24 are formed on the inner wall surface on both sides in the up-down direction in the insertion hole 23. The protruding portions 24 are configured to correspond to the plurality of locking portions 15 of the knob mounting portion 12. The protruding portions 24 protrude so as to extend inward from the inner wall surfaces at both sides in the up-down direction of the insertion hole 23, and the protruding portions 24 are formed from the opening end of the insertion hole 23 along the deep side. The spacing between the protruding portions 24 at both sides is set to be less than the width direction of the knob mounting portion 12.

The assembly of the lever main body 10 and the knob mounting portion 12 is press fitted and inserted into the insertion hole 23 of the operation knob 20. In this case, the protruding portions 24 that extend inward from the inner wall surfaces of the quadrangular cross section of the insertion hole 23 of the operation knob 20 are pushed and pressed in by the plurality of locking portions 15 of the knob mounting portion 12. Where the operation knob 20 is pushed in through a predetermined push-in length onto the knob mounting portion 12, the plurality of locking portions 15 of the knob mounting portion 12 are engaged with the respective protruding portions 24 by biting thereinto.

### SUMMARY OF THE INVENTION

In Japanese Patent Application Publication No. 2000-66750, the locking portions 15 formed at the knob mounting portion 12 are configured to bite only into the protruding portions 24. In other words, the protruding portions 24 are formed to extend in a circular-arc fashion inward from the inner wall surface of the quadrangular cross sectional shape, and since the protruding portions 24 are formed, the locking portions 15 are prevented from biting into the inner wall surface of the insertion hole 23 and the press fitting load is reduced. Since the locking portions 15 are locked so as to bite only into the protruding portions 24, the region taking part in the locking is very small and the resistance to a pull-out load is decreased between the knob mounting portion 12 and the operation knob 20.

The locking portions 15 and protruding portions 24 are pressed against each other in a mode similar to point contact. Therefore, the press-in load is reduced. However, the resistance to the pull-out load decreases to the same degree to which the press-in load is decreased. Further, since the protruding portions 24 are formed to have a circular-arc shape, the dimensions are difficult to control and a spread occurs in the bite-in amount of the locking portions 15. Where the spread occurs in the bite-in amount of the locking portions 15, the press-in load and pull-out load become unstable.

It is an object (a solution to a technical problem) of the present invention to stabilize the press-in load and pull-out load in an easy manner when assembling an operation lever device constituting a steering apparatus, reduce the press-in load acting when a knob is press fitted onto the lever, ensure very strong mounting, and facilitate dimensional control.

The inventors have conducted a comprehensive study aimed at the resolution of the above-described problems and have discovered that the abovementioned problems are resolved by the first aspect of the present invention residing in an operation lever for a steering apparatus, including: a lever main body having a tapered insertion portion which has a quadrangular cross-sectional shape and sawtooth-like locking portions on both sides in an up-down direction and in which a size in the up-down direction decreases gradually toward a distal end; and an operation knob having a tapered insertion hole which has a quadrangular cross-sectional shape and in which a size in the up-down direction decreases gradually from an opening toward a deep end wall surface, wherein the insertion hole is constituted by tapered reference surfaces facing each other in the up-down direction and inner side surfaces facing each other in a left-right direction, the tapered insertion portion of the lever main body and the tapered insertion hole of the operation knob are formed to correspond to each other, grooves are formed from the opening and along the deep end wall surface so as to protrude outward from the respective tapered reference surfaces in the corner locations of the two tapered reference surfaces and the inner side surfaces in the insertion hole of the operation knob, the insertion portion is inserted into the insertion hole, and the locking portions are configured to bite in outward through the respective tapered reference surfaces.

The abovementioned problems are also resolved by the second aspect of the present invention residing in the first aspect of the present invention wherein the grooves protrude outward in the up-down direction with respect to the tapered reference surfaces. The abovementioned problems are also resolved by the third aspect of the present invention residing in the first or second aspect of the present invention wherein the locking portions are configured to bite in outward through the respective tapered reference surfaces and the grooves.

The abovementioned problems are also resolved by the fourth aspect of the present invention residing in the first or second aspect of the present invention wherein in the locking portion, a surface on the distal end side has a bulging arched shape, and a surface on a rear end side is formed perpendicular to a pull-out direction. The abovementioned problems are also resolved by the fifth aspect of the present invention residing in the first or second aspect of the present invention wherein a tapered end surface with a thickness reducing gradually toward a distal end is formed in a distal end location of the insertion portion.

The abovementioned problems are also resolved by the sixth aspect of the present invention residing in the first or second aspect of the present invention wherein the insertion portion is formed such that a height dimension thereof increases gradually from the locking portion positioned on a front side toward the locking portion positioned on a rear side, with reference lines, provided at both sides in the up-down direction and constituting a tapered shape, being used as a reference.

The abovementioned problems are also resolved by the seventh aspect of the present invention residing in the first or second aspect of the present invention wherein the cross section of the lever main body perpendicular to the longitudinal direction thereof has a trapezoidal shape, and the cross section of the insertion hole of the operation knob perpendicular to the longitudinal direction thereof has a trapezoidal shape.

In accordance with the first aspect of the present invention, grooves are formed in the corner locations of the tapered reference surfaces and the inner side surfaces in the insertion hole, and when the insertion portion of the lever main body is inserted into the insertion hole and the insertion portion is forced to lock with the tapered reference surface by a press fitting means, the grooves play the role of escape sections, and as the insertion portion is inserted into the insertion hole, the edges are not caught and the insertion proceeds easily and smoothly. Furthermore, the locking portions of the insertion portion of the lever main body bite easily in the tapered reference surface of the insertion hole. Therefore, the locking portions of the insertion portion bite in the tapered reference surface, while expanding the interior of the insertion hole, and the lever main body and the operation knob can be joined strongly together.

Further, because of the grooves formed in the corner locations of the insertion hole, the press-in load acting when the insertion portion of the lever main body is inserted is reduced and unnecessary excessive increase in the press-in load can be prevented. In addition, due to the presence of the grooves, the dimensions of the inner wall surface of the insertion hole of the operation knob can be easily made to correspond accurately to the width and thickness dimensions of the insertion portion of the lever main body and the press-in load can be stabilized. Further, since the internal wall surface of the insertion hole that will be used for press fitting can be formed to be flat over the entire region, the surface into which the locking portions formed at the insertion portion will bite in can be enlarged and the engagement strength can be increased.

In accordance with the second aspect of the present invention, since the grooves protrude outward in the up-down direction with respect to the tapered reference surfaces, both side portions of the tapered reference surfaces in the left-right direction thereof can be easily broken through and the locking portions can easily bite therein. In accordance with the third aspect of the present invention, since the locking portions are configured to bite in outward through the respective tapered reference surfaces and the grooves, very strong joining can be performed. In accordance with the fourth aspect of the present invention, in the locking portion, the surface on the distal end side has a bulging arched shape, and the surface on the rear end side is formed perpendicular to the pull-out direction. As a result, the insertion portion can be smoothly inserted into the insertion hole, the resistance to a load in the pull-out direction can be increased, and extremely strong mounting can be stably obtained.

In accordance with the fifth aspect of the present invention, since the tapered end surface with a thickness reducing gradually toward the distal end is formed in the distal end location of the insertion portion, the thickness of the distal end of the insertion portion is made less than the size of the insertion hole in the left-right direction, insertion ability can be improved, and operation efficiency during assembling can be improved.

In accordance with the sixth aspect of the present invention, the insertion portion is formed such that the height dimension of the locking portions increases gradually from the locking portion positioned on a front side toward the locking portion positioned on a rear side, where reference lines provided at both sides in the up-down direction and constituting a tapered shape serve as a reference. With such a configuration, all of the locking portions bite reliably in the tapered reference surface of the insertion hole and strong joining of the lever main body and the operation knob can be obtained.

In particular, since the height dimension of the locking portions in the insertion portion increases gradually toward the rear locking portion with respect to the reference lines constituting the tapered shape, even if the locking portions at the distal end side of the insertion portion are somewhat deformed in the process of insertion into the insertion hole, so that the two tapered reference surfaces facing each other in the up-down direction are pushed out and the tapered reference surfaces expand in the up-down direction, the locking portions located on the rear side with respect to the distal end side can deeply bite in the tapered reference surfaces and a strong joining state of the lever main body and operation knob can be realized.

In accordance with the seventh aspect of the present invention, the cross section of the lever main body perpendicular to the longitudinal direction thereof has a trapezoidal shape, and the cross section of the insertion hole of the operation knob perpendicular to the longitudinal direction thereof has a trapezoidal shape. As a result, the bite-in amount of the locking portions into the tapered reference surfaces can be increased and the engagement strength can be increased.

### BRIEF DESCRIPTION OF THE DRAWINGS

FIG. 1A is a side view illustrating, with a cut-out portion, the assembly of the lever main body and operation knob in accordance with the present invention, FIG. 1B is a side view, with a cut-out portion, of the operation knob, FIG. 1C is a view along the Y1-Y1 arrow in FIG. 1B, FIG. 1D is an enlarged view of portion (I) in FIG. 1C, FIG. 1E is a vertical sectional view of the insertion hole of the operation knob, and FIG. 1F is an enlarged side view of the insertion portion of the lever main body;

FIG. 2A is a perspective view of the lever main body and the operation knob, FIG. 2B is a principal enlarged perspective view of the operation knob, and FIG. 2C is a side view of the steering apparatus in which the present invention is used;

FIG. 3A is a vertical sectional side view illustrating the state in which the insertion portion is inserted into the insertion hole, engaged therewith, and fixed thereto, FIG. 3B is a sectional view along the Y2-Y2 arrow in FIG. 3A, FIG. 3C is an enlarged view of portion (II) in FIG. 3B, FIG. 3D is an enlarged view of portion (III) in FIG. 3C, and FIG. 3E is a principal perspective view illustrating the locked state of the insertion portion in the insertion hole;

FIG. 4A is a vertical sectional side view illustrating the initial state of insertion of the insertion portion into the insertion hole, FIG. 4B is a sectional view along the Y3-Y3 arrow in FIG. 4A, FIG. 4C is a vertical sectional side view illustrating the intermediate state of the process in which the insertion portion is inserted into the insertion hole, FIG. 4D is a sectional view along the Y4-Y4 arrow in FIG. 4C, FIG. 4E is a vertical sectional view illustrating the state after the insertion portion has been locked and fixed to the insertion hole, and FIG. 4F is a sectional view along the Y5-Y5 arrow in FIG. 4E;

FIG. 5A is a front view of the opening of the insertion hole according to the embodiment in which the groove has a square cross-sectional shape, and FIG. 5B is a front view of the opening of the insertion hole according to the embodiment in which the groove has a trapezoidal cross-sectional shape;

FIG. 6A is a perspective view illustrating the embodiment in which the taper end surface has been formed in the insertion portion of the lever main body, and FIG. 6B is a view along the X1-X1 arrow in FIG. 6A;

FIG. 7A is a side view with a partial section illustrating the state after the insertion portion of the lever main body according to the second embodiment of the present invention has been inserted into the insertion hole of the operation knob, and FIG. 7B is an enlarged view of portion (VI) in FIG. 7A;

FIG. 8A is a side view of the insertion portion of the lever main body according to the third embodiment of the present invention, FIG. 8B is an enlarged sectional view along the Y6-Y6 arrow in FIG. 8A, FIG. 8C is a front view of the operation knob according to the third embodiment of the present invention, FIG. 8D is an enlarged view of portion (V) in FIG. 8C, FIG. 8E is a side view, with a partial section, illustrating the state after the insertion portion of the lever main body according to the third embodiment of the present invention has been inserted into the insertion hole of the operation knob, FIG. 8F is an enlarged sectional view along the Y7-Y7 arrow in FIG. 8E, FIG. 8G is a vertical sectional front view illustrating the state of the insertion portion and insertion hole in a variation example of the third embodiment of the present invention, and FIG. 8H is a vertical sectional front view illustrating the state of the insertion portion and insertion hole in another variation example of the third embodiment of the present invention; and

FIG. 9A is a principal enlarged view illustrating the state in which the locking portions according to the third embodiment of the present invention have bitten into the tapered reference surface, and FIG. 9B is a sectional view illustrating the state of load created by the insertion portion inserted into the insertion hole in the third embodiment.

### DESCRIPTION OF THE PREFERRED EMBODIMENTS

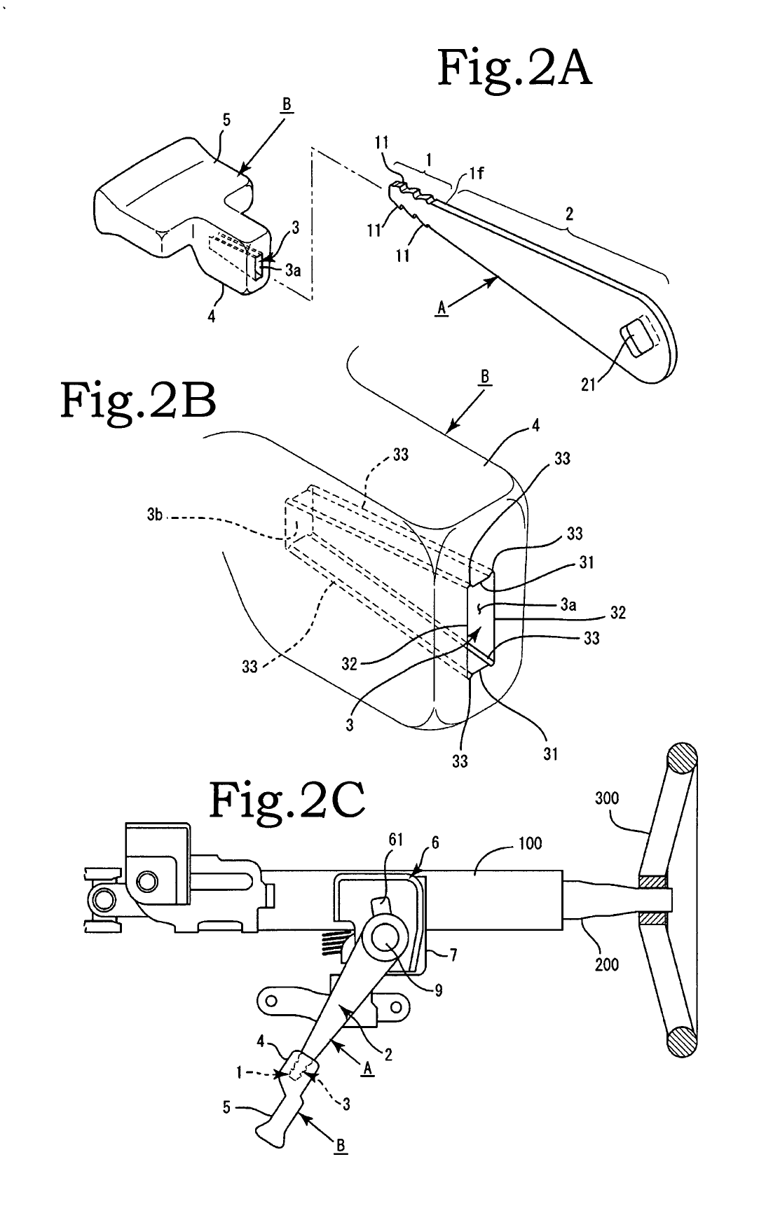

The embodiments of the present invention will be described below with reference to the appended drawings. The present invention relates to the operation lever portion of a tilt-telescopic adjustment mechanism of a steering apparatus. In accordance with the present invention, as shown in FIG. 2C, the configuration of the steering apparatus is constituted mainly by a lever main body A, an operation knob B, a fixed bracket 6, a movable bracket 7, and a steering column 100. In the fixed bracket 6, elongated holes 61 for tilting are formed in a circular arc shape substantially along the up-down direction and the below-described tilt bolt 9 is passed therethrough.

The steering column 100 is fixedly attacked to the lower end zone of the movable bracket 7. The steering column 100 and the movable bracket 7 are fixedly attached by welding or the like. A steering shaft 200 is rotatably mounted on the steering column 100, and a steering wheel 300 is mounted on the distal end of the steering shaft 200.

The fixed bracket 6 and the movable bracket 7 are joined together by the tilt bolt 9, and the brackets are tightened or released by the tilt bolt 9. The below-described lever main body A is mounted on the tilt bolt 9, and locking and unlocking in the tilt-telescopic adjustment is performed by the lever main body A and the operation knob B.

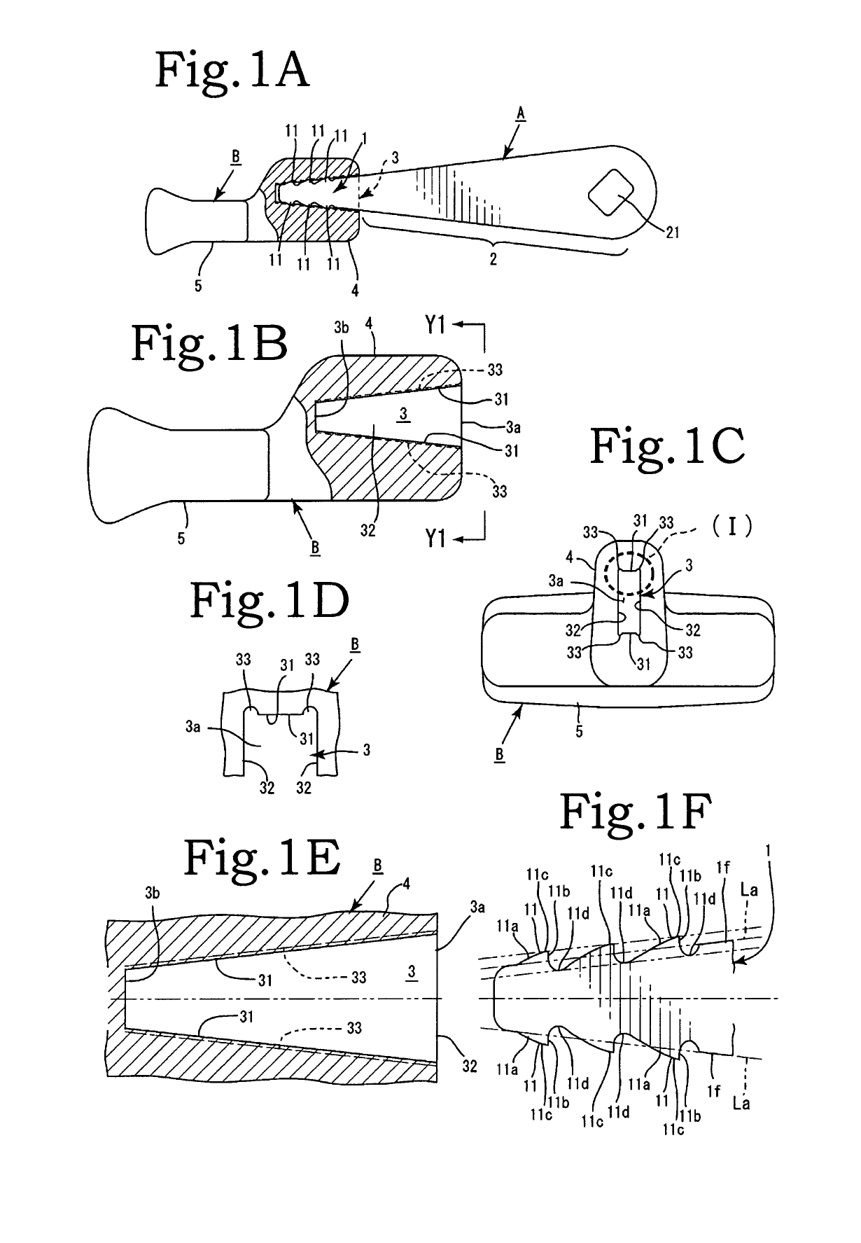

As shown in FIGS. 1A, 1F and 2A, the lever main body A is constituted by an insertion portion 1 and a lever portion 2. The insertion portion 1 is formed integrally with the distal end of the lever portion 2. The lever main body A is formed from a plate-like metal material and processed to the desired lever shape by press punching (see FIG. 2A). The insertion portion 1 is designed to be inserted into an insertion hole 3 of the below-described operation knob B.

The insertion portion 1 of the lever main body A and the insertion hole 3 of the operation knob B are formed to be locked and fixed. An attachment hole 21 serving as a swinging center is formed by punching at the other end of the lever portion 2 in the longitudinal direction thereof. The insertion portion 1 is formed in a tapered shape such that the distance between both ends thereof in the up-down direction decreases gradually toward the distal end of the insertion portion (see FIG. 1F).

Both the insertion portion 1 and the lever portion 2 of the lever main body A have a quadrangular cross-sectional shape perpendicular to the pull-out direction (longitudinal direction). The quadrangular shape as referred to herein is the shape having four corners, more specifically a trapezoidal shape or a rectangular shape, inclusive of a substantially rectangular shape. The present invention includes a plurality of embodiments, and explained hereinbelow is the first embodiment in which the cross section perpendicular to the pull-out direction (longitudinal direction) of the lever main body A has a rectangular shape. In the explanation of the present invention, the direction along the long sides of the rectangle is taken as the up-down direction. In the insertion portion 1, sawtooth-like locking portions 11 are formed at both sides in the up-down direction (see FIG. 1F).

In the insertion portion 1, engagement surfaces 1f which are regions located close to the boundary with the lever portion 2 and having no locking portions 11 therein are formed at both sides in the up-down direction (see FIGS. 1F and 2A). A plurality of locking portions 11 are formed at the upper and lower sides. More specifically, three locking portions are formed at each side. In each locking portion 1, the surface on the distal end side is a bulging arched surface 11a and the surface on the rear end side is a perpendicular surface 11b that is formed at a right angle to the pull-out direction (longitudinal direction) of the lever main body A (see FIG. 1E).

Therefore, when the insertion portion 1 of the lever main body A is inserted into the insertion hole 3 of the operation knob B, as described hereinbelow, since the bulging arched surface 11a is positioned at the distal end side in the advance direction of such insertion, the insertion of the insertion portion 1 into the insertion hole 3 proceeds smoothly. Since the perpendicular surface 11b is present at the rear end side, the insertion portion 1 that has once been inserted into the insertion hole 3 offers very strong resistance to the load in the pull-out direction, thereby providing for high durability. Reference lines La are present at both sides in the up-down direction in the insertion portion 1. The two reference lines La indicate the slope of the tapered shape of the insertion portion 1.

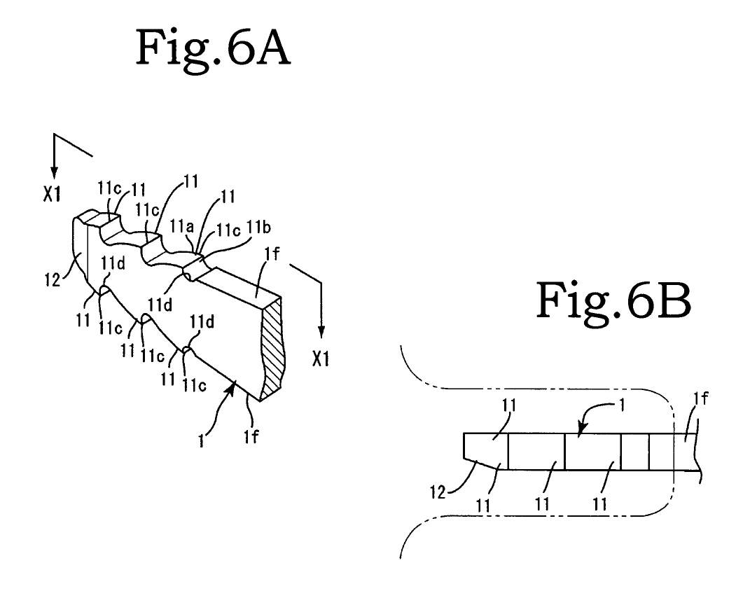

More specifically, the reference line La is a virtual line extending along the engagement surface 1f. A peak portion 11c and a valley portion 11d of the locking portion 11 are present in relation to the reference line La. A tapered end surface 12 is formed at the distal end section of the insertion portion 1. The thickness of the tapered end portion decreases gradually toward the distal end (see FIG. 6B).

The engagement surface 1f is a flat surface and, as described above, serves as a base surface of the slope of the reference line La. After the insertion portion 1 has been inserted into the insertion hole 3, the engagement surface 1f is located close to a tapered reference surface 31 or abuts thereon and has a constant length. Further, the engagement surface 1f is formed over a very small range.

As shown in FIGS. 1B to 1E, 2A, and 2B, the operation knob B is constituted by a lever receiving portion 4 and a grasping portion 5. The lever receiving portion 4 and the grasping portion 5 are both formed in a plate-like shape and formed integrally so as to be perpendicular to each other (see FIGS. 1C and 2A). The lever receiving portion 4 and the grasping portion 5 are molded integrally by injection molding of a resin, and the lever receiving portion 4 is formed to protrude outward from the central location of the grasping portion 5 in the width direction thereof. The insertion hole 3 is formed in the lever receiving portion 4.

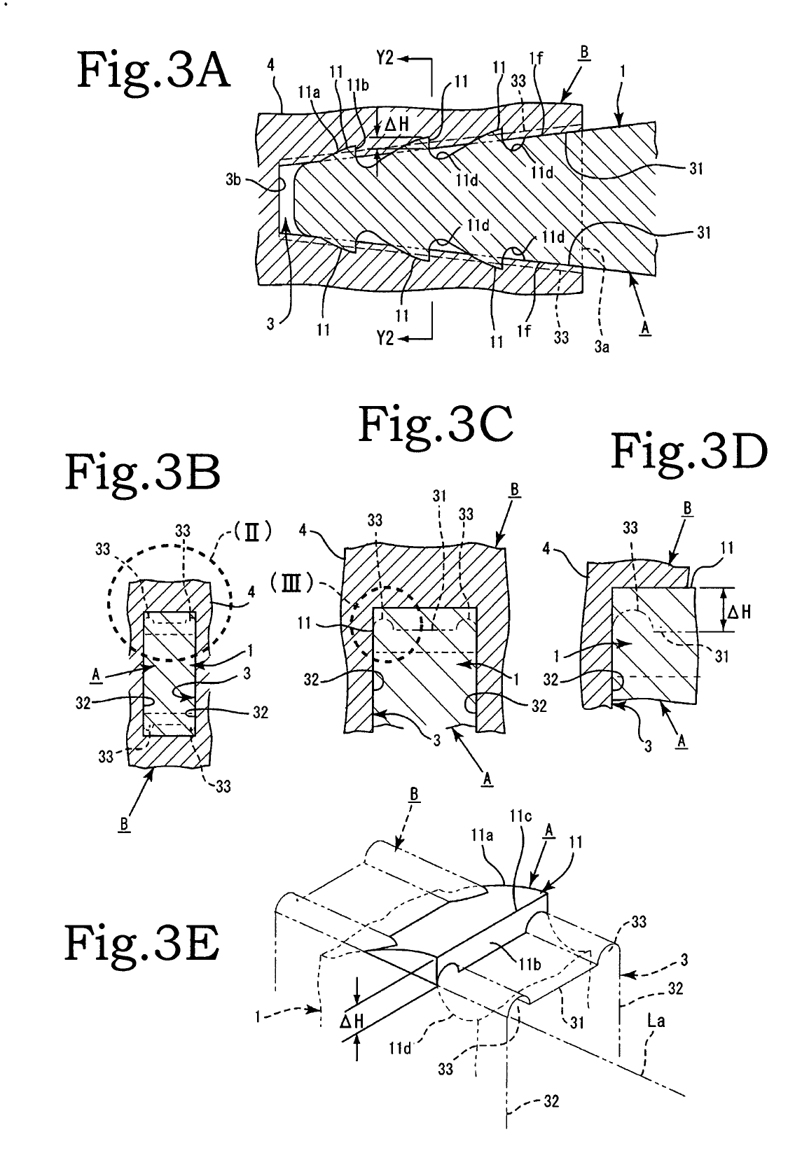

The cross section of the insertion hole 3 perpendicular to the longitudinal direction of the hole has a rectangular shape and formed in a tapered shape such that the size thereof in the up-down direction decreases gradually from an opening 3a of the insertion hole 3 toward a deep end wall surface 3b (see FIGS. 1B, 1E, and 2B). The insertion hole 3 forms a tapered cavity, and the inner wall surfaces thereof facing each other in the up-down direction are referred to as tapered reference surfaces 31. The inner wall surfaces facing each other in the left-right direction are referred to as inner surfaces 32. The two tapered reference surfaces 31 and the two reference lines La in the insertion portion 1 of the lever main body A are tapered to have the same (inclusive of substantially the same) gradient (see FIGS. 1E, 1F, and 3A).

Grooves 33 protruding outward in the up-down direction from respective tapered reference surfaces 31 are formed in the corner zones of the two tapered reference surfaces 31 and the two inner surfaces 32 (see FIGS. 1C and 1D). In other words, the two grooves 33 formed at both ends in the left-right direction of the upper tapered reference surface 31 are formed to protrude upward, and the two grooves 33 formed in the lower tapered reference surface 31 are formed to protrude downward. The distance between the two inner surfaces 32 corresponds to the thickness of the insertion portion 1 of the lever main body A so that the insertion portion could be fitted in without a play.

When the operation knob B is a resin molded product that is molded so that the insertion hole 3 has a perfect quadrangular cross section, the four corner portions are formed in a rounded (arched) shape, and when the knob mounting portion is inserted the rounded portions of the four corners are caught by the insertion portion 1 and the resistance to the press-in operation increases. However, where the grooves 33 are formed in the insertion hole 3, the grooves 33 play the role of escape portions when the insertion portion 1 is inserted in the lever receiving portion 4, the corner portions of the insertion hole 3 can be prevented from being caught by the insertion portion 1, and a low resistance during insertion can be set.

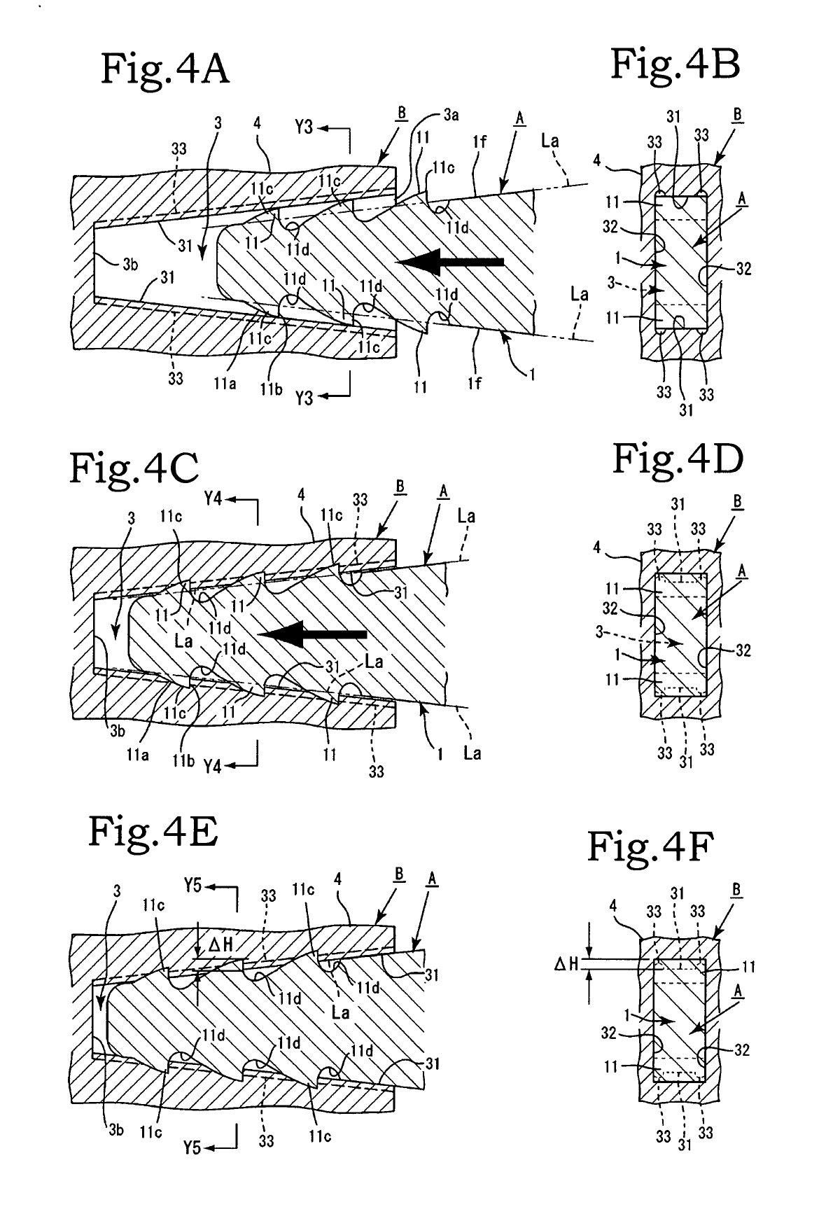

The assembled structure of the lever main body A and the operation knob B will be explained below. The positions of the upper and lower ends of the insertion portion 1 of the lever main body A are aligned with the positions of the upper and lower ends of the insertion hole 3 of the operation knob B. Then, the insertion portion 1 of the lever main body A is inserted into the insertion hole 3 of the operation knob B. Since the tapered end surface 12 is formed in the distal end location of the insertion portion 1, the thickness of the distal end of the insertion portion 1 is less than the distance between the two inner surfaces 32 of the insertion hole 3 and the insertion ability increases. The two reference lines La of the locking portions 11 of the lever main body A are parallel to the respective tapered reference surfaces 31 of the insertion hole 3. Further, the distal ends of the locking portions 11 abut on the two tapered reference surfaces 31 (see FIGS. 4A and 4B).

Where the lever receiving portion 4 is then pushed against the operation knob B, the upper and lower locking portions 11 start biting in the upper and lower tapered reference surfaces 31. The grooves 33 are located at both ends of the tapered reference surface 31 in the left-right direction thereof, and because of these grooves 33, the tapered reference surface 31 has a structure in which both ends in the width direction can be easily broken through and the peak-like portions 11c of the locking portions 11 easily bite in.

Where the lever main body A is further pushed into the operation knob B, the two reference lines La and engagement surfaces 1f of the insertion portion 1 match the two tapered reference surfaces 31 of the insertion hole 3, and the peak-like portions 11c of the locking portions 11 bite in through the upper ends of the grooves 33 located on the upper side or lower ends of the grooves 33 located on the lower side to reach the body section of a connection portion 4 where the insertion hole 3 has been formed (see FIGS. 3E, 4C, and 4D).

Thus, the locking portions 11 of the insertion portion 1 of the lever main body A bite in and locked to the insertion hole 3 of the operation knob B in a state in which the insertion hole is expanded beyond the initial size of the opening 3a (see FIGS. 3A to 3D). The bite-in amount of the peak-like portion 11c of the locking portion 11 is represented as ΔH (see FIGS. 3D, 3E, and 4E). The bite-in amount ΔH is the distance from the tapered reference surface 31 to the topmost zone of the peak-like portion 11c of the locking portion 11.

Thus, in the insertion portion 1 of the lever main body A, under the effect of the locking portions 11 at both ends in the up-down direction, the peak-like portions 11c of the locking portions 11 bite in to reach the positions beyond the region where the tapered reference surfaces 31 and grooves 33 at both ends in the up-down direction of the insertion hole 3 of the operation knob B are formed. As a result, a very strong joint is obtained. In particular, FIG. 3E shows a state in which part of the peak-like portion 11c of the locking portion 11 of the insertion portion 1 has bitten in the body section of the lever receiving portion 4 in the insertion hole 3 through the formation region of the grooves 33.

When the insertion portion 1 is further inserted into the insertion hole 3, because of the presence of grooves 33 formed at the upper and lower ends of the insertion hole 3, the locking portions 11 of the insertion portion 1 can be directly locked with the tapered reverence surfaces 31 of the insertion hole 3, without the necessity of forming any protrusions that protrude inward as the portions to be locked on the tapered reference surfaces 31. Furthermore, since the entire insertion region of the insertion hole 3 into which the insertion portion 1 is pressed is a flat surface, accurate dimensional control can be performed. Therefore, the load that presses the lever main body A into the insertion hole 3 can be stabilized.

Since the grooves 33 are formed at both ends in the width direction of the tapered reference surfaces 31 of the insertion hole 3, the corner portions of the tapered reference surfaces 31 and the inner surfaces 32 are not directly continuous. For this reason, the tapered reference surface 31 can be formed as a flat surface over the entire span in the left-right direction. As a result, the surface area of the tapered reference surfaces 31 into which the locking portions 11 of the insertion portion 1 bite in can be expanded to a maximum limit and the locking strength is increased.

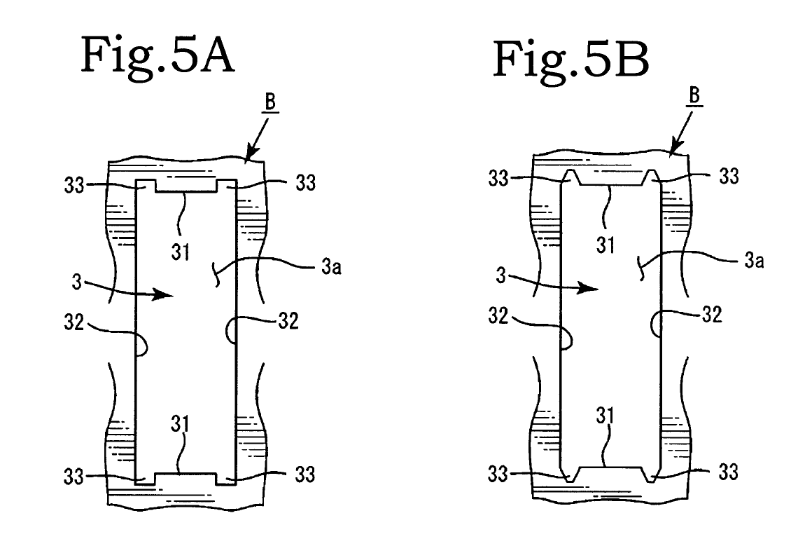

The grooves 33 formed in the insertion hole 3 may have a semicircular or curved cross-sectional shape, and also may have a polygonal shape. Specific examples include a square cross-sectional shape (see FIG. 5A) and a trapezoidal cross-sectional shape (see FIG. 5B).

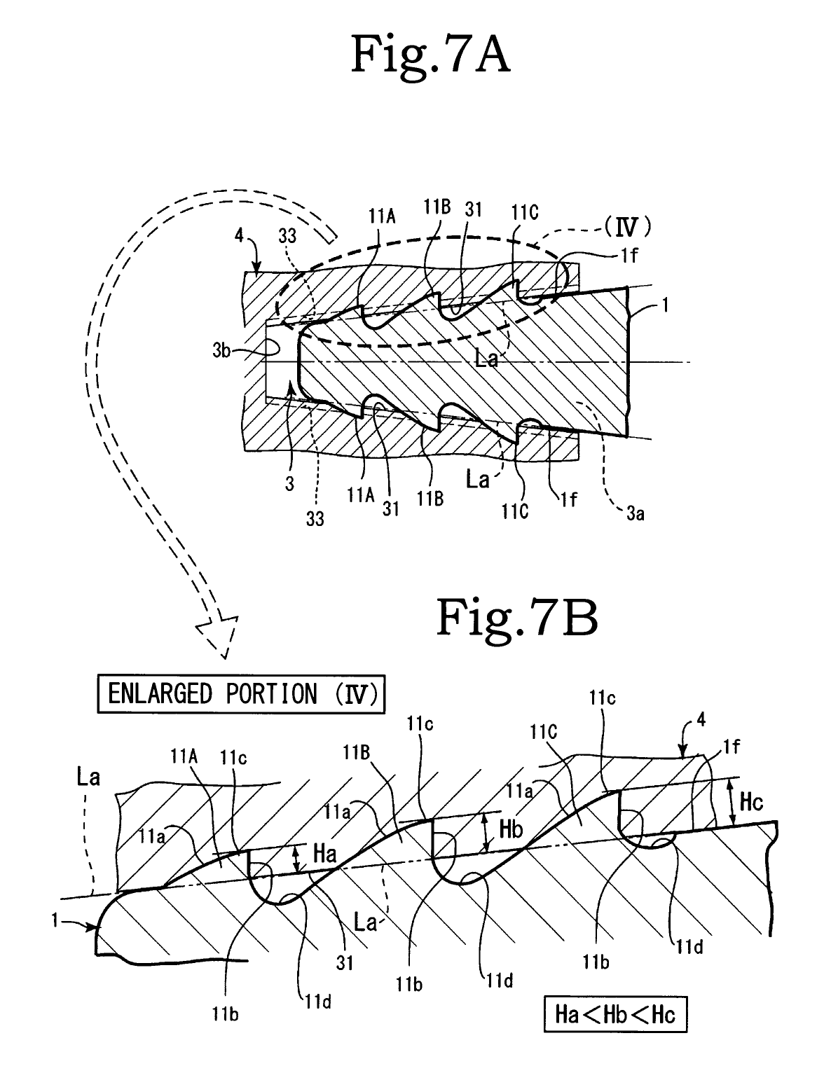

The second embodiment of the present invention will be explained below with reference to FIG. 7. In the second embodiment, a plurality of the sawtooth-like locking portions 11 formed at both sides in the up-down direction of the insertion portion 1 of the lever main body A are formed such that the height dimension thereof increases gradually from the locking portion 11 positioned on the front side toward the locking portion 11 positioned on the rear side (see FIGS. 7A and 7B).

Explaining this embodiment in greater detail, the reference lines La constituting the tapered shape are provided, as described hereinabove, at both sides of the insertion portion 1 in the up-down direction. The height dimension of the plurality of locking portions 11 formed at both sides of the insertion portion 1 in the up-down direction is set with respect to the reference line La.

In the second embodiment, the locking portions 11 formed in the insertion portion 1 are formed by three locking portions on either of the two sides in the up-down direction.

For the sake of convenience, the locking portion 11 positioned at the front end of insertion will be referred to as a distal-end locking portion 11A, the locking portion 11 positioned in the intermediate zone will be referred to as an intermediate locking portion 11B, and the locking portion 11 positioned at the rear end will be referred to as a rear-end locking portion 11C. In FIG. 7, the number of locking portions 11 in the insertion portion 1 is three on each side in the up-down direction, but the present invention is not limited to this number and the number of locking portions may be other than three.

The distal-end locking portion 11A, intermediate locking portion 11B, and rear-end locking portion 11C are formed such that the height dimension thereof increases from the front side toward the rear side, with the reference line La serving as a reference. Thus, where the height dimension of the distal-end locking portion 11A is denoted by Ha, the height dimension of the intermediate locking portion 11B is denoted by Hb, and the height dimension of the rear-end locking portion 11C is denoted by Hc, the following condition is satisfied: Ha<Hb<Hc, where the reference line La serves as a reference.

Where the insertion portion 1 of the lever main body A of the above-described configuration is inserted into the insertion hole 3 of the operation knob B, the plurality of locking portions 11 formed on both sides of the insertion portion 1 in the up-down direction bite even deeper in the two tapered reference surfaces 31 on both sides of the insertion hole 3 in the up-down direction and lock with the tapered reference surfaces (see FIGS. 7C and 7D). In particular, when the three locking portions 11 are provided on either side in the up-down direction, the intermediate locking portion 11B bites deeper than the distal-end locking portion 11A in the tapered reference surface 31, and the rear-end locking portion 11C bites even deeper than the intermediate locking portion 11B in the tapered reference surface 31 (see FIG. 7D).

Further, when the insertion portion 1 is inserted in the insertion hole 3, the penetration into the insertion hole 3 is started from the distal-end locking portions 11A, and the insertion portion 1 advances toward the deep-end wall surface 3b as the distal-end locking portions 11A formed at both sides of the insertion portion 1 in the up-down direction push and expand the two tapered reference surfaces 31. Since the tapered reference surfaces 31 are thus pushed and expanded by the distal-end locking portions 11A, a certain deformation is induced and the spacing is locally increased.

In this case, the height dimension of the intermediate locking portion 11B and rear-end locking portion 11C with respect to the reference line La is also larger than that of the distal-end locking portion 11A. Therefore, the sufficient bite-in amount into the tapered reference surfaces 31 can be reliably ensured and the resistance to the load in the pull-out direction can be increased.

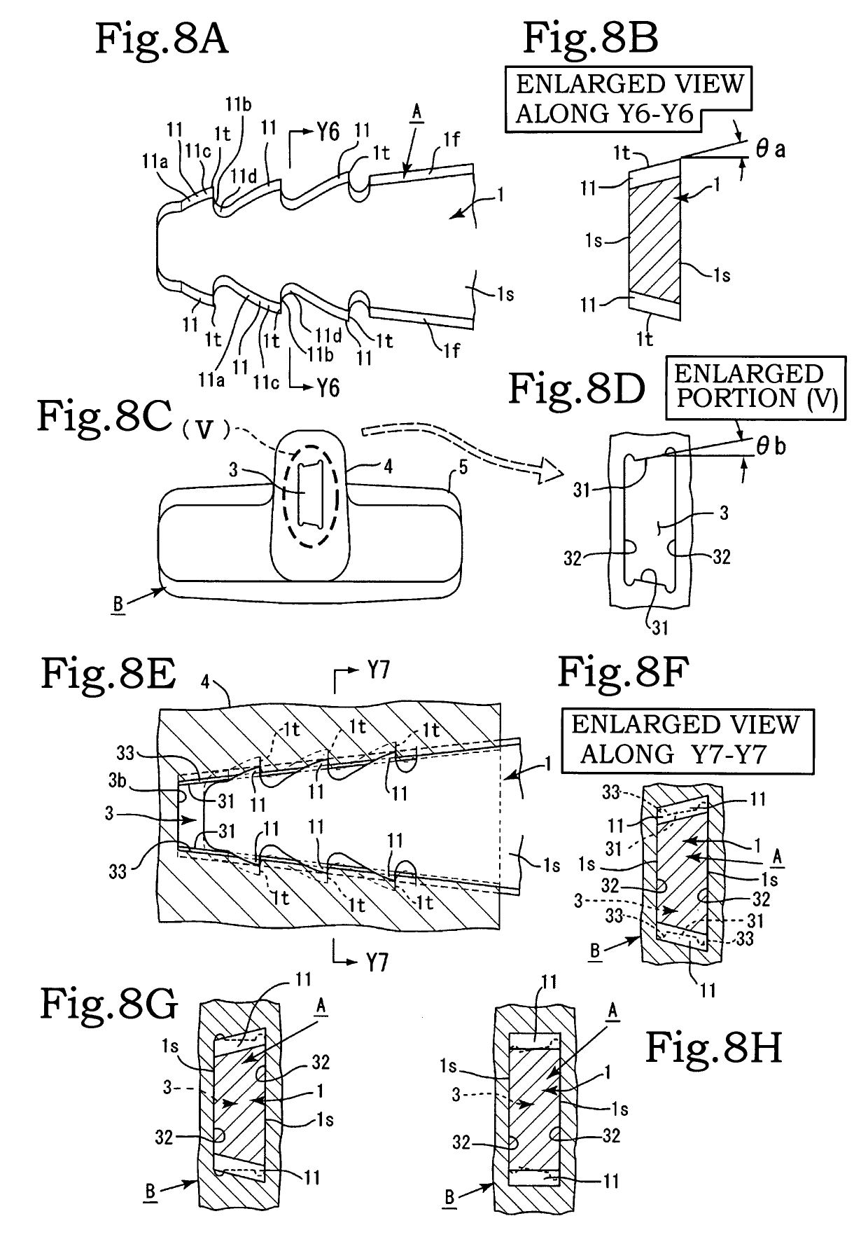

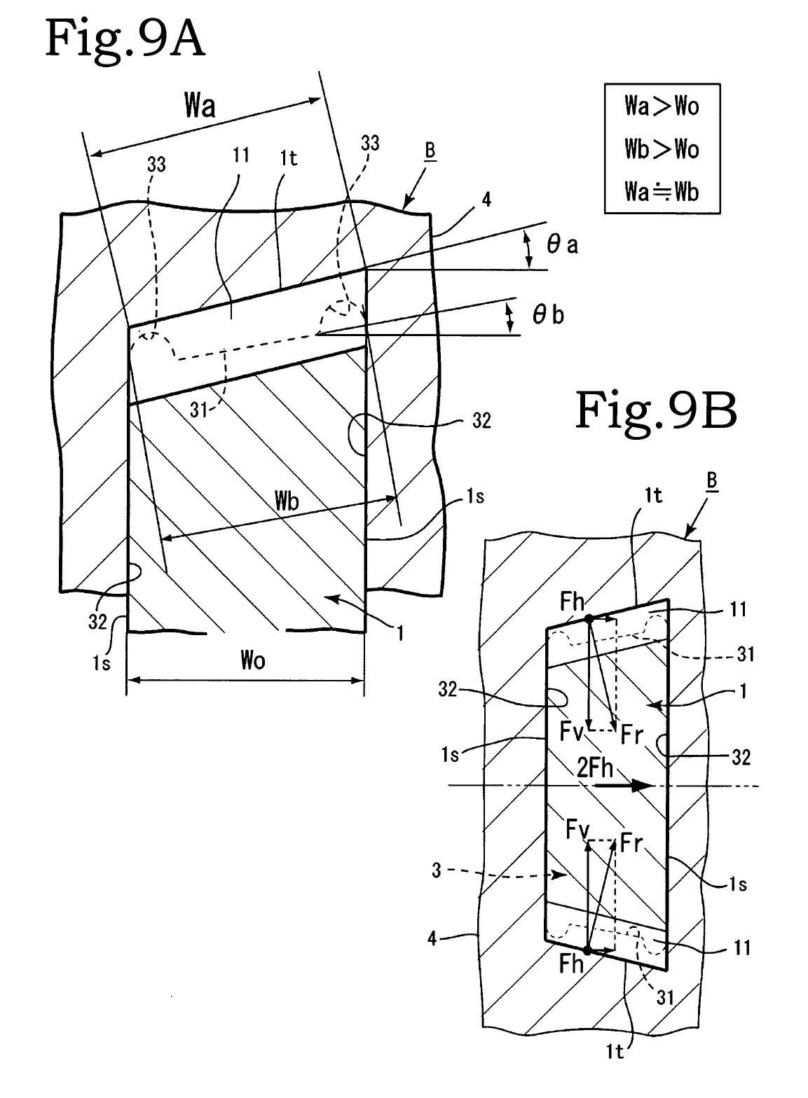

The third embodiment of the present invention will be explained below with reference to FIGS. 8 and 9. In the third embodiment, the cross-section of the insertion portion 1 of the lever main body A and the insertion hole 3 of the operation knob B, which have a quadrangular shape, that is perpendicular to the longitudinal direction thereof has a trapezoidal shape (inclusive of a substantially trapezoidal shape) (see FIGS. 8A to 8D). More specifically, in the insertion portion 1 of the lever main body A, the side surfaces 1s on both sides in the width direction are parallel to each other (inclusive of substantially parallel), and both ends in the up-down direction are tilted symmetrically along the width direction.

Both ends of the insertion portion 1 in the up-down direction, as referred to herein, are apex portions of the peak-like portions 11c of the locking portions 11 on both sides. In order to facilitate the explanation below, the apex portions of both peak-like portions 11c at both ends of the insertion portion 1 in the up-down direction will be taken as both ends of the insertion portion 1 in the up-down direction and the positions thereof will denoted as the respective apex portions 1t. Both sides of the insertion portion 1 in the width direction will be denoted as respective side surfaces 1s.

The apex portions 1t at both ends in the up-down direction are formed to be tilted symmetrically with respect to a vertical axis along the width direction (thickness direction) of the insertion portion 1 (see FIG. 8B). Thus, the cross section of the insertion portion 1 perpendicular to the longitudinal direction thereof has a trapezoidal shape such that the two side surfaces 1s in the width direction are parallel to each other and the two apex portions 1t at both ends in the up-down direction are tilted symmetrically with respect to a vertical axis. The tilting angle of the apex portion 1t with respect to a (virtual) horizontal line is taken as θa (see FIGS. 8B and 9A).

When the lever main body A is obtained by press forming a metal material, the trapezoidal shape of the cross-section perpendicular to the longitudinal direction is naturally obtained when the metal material that has been set in a die of a press is punched with a punch.

The insertion hole 3 of the operation knob B is also formed such that the cross-section perpendicular to the longitudinal direction thereof has a trapezoidal shape. The trapezoidal cross-sectional shape of the insertion hole 3 is formed to correspond to the trapezoidal cross-sectional shape of the lever main body A (see FIGS. 8C and 8D). Thus, the inner surfaces 32 of the insertion hole 3 are parallel to each other, and the two tapered reference surfaces 31 are formed to tilt symmetrically with respect to a vertical axis along the width direction. Thus, the cross section of the insertion hole 3 perpendicular to the longitudinal direction thereof has a trapezoidal shape such that the two inner surface 32 in the width direction are parallel to each other and the two tapered reference surfaces 31 at both ends in the up-down direction are tilted symmetrically with respect to a vertical axis.

The tilting angle of the tapered reference surface 31 with respect to a (virtual) horizontal line is taken as θb (see FIGS. 8D and 9A). The tilting angle θa of the aforementioned apex portions 1t and the tilting angle θb of the tapered reference surface 31 are identical or slightly different.

Since the cross sections of the insertion portion 1 of the lever main body A and the insertion hole 3 of the operation knob B that are perpendicular to the longitudinal direction thereof have a trapezoidal shape, the locking portions 11 can bite in through the grooves 33 over the entire surface of the tapered reference surfaces 31, the resistance to the load in the pull-out direction can be increased and an even stronger connection structure can be obtained. More specifically, where the insertion portion 1 is formed such that the cross section perpendicular to the longitudinal direction thereof has a trapezoidal shape, the locking portions 11 formed at the insertion portion 1 are tilted along the width direction and therefore the size in the width direction is increased with respect to that in the case of the horizontal width direction.

In other words, when the trapezoidal cross-sectional shape is obtained, instead of the shape in which both ends of the insertion portion 1 in the up-down direction are parallel to each other, the length Wa of the apex portion 1t tilted in the width direction is [Wo/(cos θa)] in a case of tilting by the tilting angle θa (see FIG. 9A). The Wo is a size of the insertion hole 3 in the horizontal width direction. Since the tilting angle θa is less than 90 degrees, the condition Wa>Wo is satisfied. Thus, the length Wa of the apex portion 1t of the insertion portion 1 tilted in the width direction is larger than the size Wo of the insertion hole 3 in the horizontal width direction. As a result, the length over which the locking portion 11 bites in the tapered reference surface 31 increases (see FIG. 9A).

Since the insertion hole 3 of the operation knob B is formed to have a trapezoidal cross section correspondingly to the cross-sectional shape of the lever main body A, the area of the tapered reference surface 31 is increased and the area of surface contact thereof with the locking portions 11 is increased. Thus, the tapered reference surface 31 of the insertion hole 3 is tilted at the tilting angle θb and the length Wb of the tapered reference surface 31 tilted in the width direction is [Wo/(cos θb)]. Since the tilting angle θa is less than 90 degrees, the condition Wb>Wo is satisfied. Thus, the length Wb of the tapered reference surface 31 tilted in the width direction is larger than the size Wo of the insertion hole 3 in the horizontal width direction. As a result, the length over which the locking portion 11 bites in the tapered reference surface 31 increases (see FIG. 9A).

Therefore, where the cross section of the insertion portion 1 perpendicular to the longitudinal direction thereof and the cross section of the insertion hole 3 perpendicular to the longitudinal direction thereof both have trapezoidal shapes, the length of the apex portion 1t of the insertion portion 1 and the length of the tapered reference surface 31 of the insertion hole 3 increase and the bite-in amount of the locking portions 11 also increases. In addition, the locking portions 11 can bite in through the grooves 33 over the entire surface of the tapered reference surfaces 31 and a stronger joined structure of the lever main body A and the insertion hole 3 can be obtained.

As a result, although the height dimension of the locking portions 11 is decreased and the bite-in amount with respect to the tapered reference surfaces 31 is also decreased, the resistance to a load in the pull-out direction can be maintained. Therefore, the size of the lever main body A in the up-down direction can be reduced, thereby reducing the weight thereof. Further, even when the size tolerance of the locking portions 11 is strictly set, the resistance to a load in the pull-out direction can be maintained, thereby making it possible to perform dimensional control and increase productivity.

Where both the insertion portion 1 of the lever main body A and the insertion hole 3 of the operation knob B have a trapezoidal shape, when the insertion portion 1 is inserted into the insertion hole 3, a reaction force Fr acts from the apex portion 1t upon the insertion hole 3 from the insertion hole 3 side in the direction perpendicular to the tilting direction. This reaction force Fr can be divided into a horizontal force component Fh and a vertical force component Fv.

Where the insertion portion 1 is pushed while being inserted into the insertion hole 3, the insertion portion 1 is pushed against one side in the width direction by a resultant force 2Fhv of the two horizontal force components Fh, this resultant force acting in the up-down direction. Further, both vertical force components Fv in the up-down direction enable the locking portions 11 to bite stronger in the tapered reference surfaces 31.

As a variation example of the third embodiment, the insertion portion 1 of the lever main body A can have a trapezoidal cross section and the insertion hole 3 of the operation knob B can have a rectangular cross section (see FIG. 8G). As another variation example of the third embodiment, the insertion hole 3 of the operation knob B can have a trapezoidal cross section and the insertion portion 1 of the lever main body A can have a rectangular cross section (see FIG. 8H).

1. An operation lever for a steering apparatus, comprising:
a lever main body having a tapered insertion portion which has a quadrangular cross-sectional shape and sawtooth-like locking portions on both sides in an up-down direction and in which a size in the up-down direction decreases gradually toward a distal end; and
an operation knob having a tapered insertion hole which has a quadrangular cross-sectional shape and in which a size in the up-down direction decreases gradually from an opening toward a deep end wall surface, wherein
the insertion hole is constituted by tapered reference surfaces facing each other in the up-down direction and inner side surfaces facing each other in a left-right direction,
the tapered insertion portion of the lever main body and the tapered insertion hole of the operation knob are formed to correspond to each other, grooves are formed from the opening and along the deep end wall surface so as to protrude outward from the respective tapered reference surfaces in corner locations of the two tapered reference surfaces and the inner side surfaces in the insertion hole of the operation knob,
the insertion portion is inserted into the insertion hole, and the locking portions are configured to bite in outward through the respective tapered reference surfaces.

2. The operation lever for a steering apparatus according to claim 1, wherein the grooves protrude outward in the up-down direction with respect to the tapered reference surfaces.

3. The operation lever for a steering apparatus according to claim 1, wherein the locking portions are configured to bite in outward through the respective tapered reference surfaces and the grooves.

4. The operation lever for a steering apparatus according to claim 1, wherein in the locking portion, a surface on a distal end side has a bulging arched shape, and a surface on a rear end side is formed perpendicular to a pull-out direction.

5. The operation lever for a steering apparatus according to claim 1, wherein a tapered end surface with a thickness reducing gradually toward a distal end is formed in a distal end location of the insertion portion.

6. The operation lever for a steering apparatus according to claim 1, wherein the insertion portion is formed such that a height dimension thereof increases gradually from the locking portion positioned on a front side toward the locking portion positioned on a rear side, with reference lines, provided at both sides in the up-down direction and constituting a tapered shape, being used as a reference.

7. The operation lever for a steering apparatus according to claim 1, wherein the cross section of the lever main body perpendicular to the longitudinal direction thereof has a trapezoidal shape, and the cross section of the insertion hole of the operation knob perpendicular to the longitudinal direction thereof has a trapezoidal shape.

8. The operation lever for a steering apparatus according to claim 2, wherein the locking portions are configured to bite in outward through the respective tapered reference surfaces and the grooves.

9. The operation lever for a steering apparatus according to claim 2, wherein in the locking portion, a surface on a distal end side has a bulging arched shape, and a surface on a rear end side is formed perpendicular to a pull-out direction.

10. The operation lever for a steering apparatus according to claim 2, wherein a tapered end surface with a thickness reducing gradually toward a distal end is formed in a distal end location of the insertion portion.

11. The operation lever for a steering apparatus according to claim 2, wherein the insertion portion is formed such that a height dimension thereof increases gradually from the locking portion positioned on a front side toward the locking portion positioned on a rear side, with reference lines, provided at both sides in the up-down direction and constituting a tapered shape, being used as a reference.

12. The operation lever for a steering apparatus according to claim 2, wherein the cross section of the lever main body perpendicular to the longitudinal direction thereof has a trapezoidal shape, and the cross section of the insertion hole of the operation knob perpendicular to the longitudinal direction thereof has a trapezoidal shape.
